(19) United States
(12) Patent Application Publication
(10) Pub. No.: US 2023/0049512 A1
(43) Pub. Date: Feb. 16, 2023

(54) SPLITTABLE BLOCKCHAIN BASED OWNERSHIP VERIFICATION

(71) Applicant: FUJITSU LIMITED, Kawasaki-shi (JP)

(72) Inventors: Avradip MANDAL, Kirkwood, CA (US); Hart MONTGOMERY, San Francisco, CA (US); Arnab ROY, Santa Clara, CA (US)

(73) Assignee: FUJITSU LIMITED, Kawasaki-shi (JP)

(21) Appl. No.: 17/401,221

(22) Filed: Aug. 12, 2021

(51) Int. Cl. H04L 9/32; H04L 9/14

(52) U.S. Cl. CPC H04L 9/3239; H04L 9/3218; H04L 9/3213; H04L 9/14; H04L 2209/38

(57) ABSTRACT

A method may include splitting an original token into a first sub-token and a second sub-token, generating a first hash value of the first sub-token and a first randomness value, and generating a second hash value of the second sub-token and a second randomness value. The method may also include evaluating an NIZKP regarding the split, and sampling first and second signature keys and verification keys associated with the first and second sub-tokens, respectively. The method may additionally include generating first and second signed values of concatenations of the first and second hash values and the first and second verification keys, respectively, and signed using an initial signature key of a current owner of the original token. The method may additionally include sending the NIZKP, the first and second hash values, the first and second signed values, and the first and second verification keys to the blockchain.

### FIELD

Embodiments of the present disclosure relate to blockchain based ownership verification.

### BACKGROUND

Verifying ownership can be a difficult process. For example, someone seeking to verify that they are the owner of some asset may be required to provide various components or involve a third party to verify their ownership. However, in many circumstances, such ownership verification has been unchanged for many years.

### SUMMARY

One or more embodiments of the present disclosure may include a method that includes obtaining, by a first entity, a verification key from a second entity to which an asset is to be transferred. The method may also include proving to an administrator of a blockchain that the first entity is a current owner of the asset, the blockchain hosting a token associated with the asset. The method may additionally include providing an updated randomness value and the token to the second entity. The method may also include sending an updated hash value of the token and the updated randomness, a signed indication of the transfer of the asset from the first entity to the second entity, and the verification key of the second entity to an administrator of the blockchain.

One or more embodiments of the present disclosure may include a method that includes splitting an original token into a first sub-token and a second sub-token, generating a first hash value of the first sub-token and a first randomness value, and generating a second hash value of the second sub-token and a second randomness value. The method may also include evaluating a non-interactive zero knowledge proof regarding the split of the original token into the first sub-token and the second sub-token, and sampling a first signature key and first verification key associated with the first sub-token and a second signature key and second verification key associated with the second sub-token. The method may additionally include generating a first signed value of a concatenation of the first hash value and the first verification key and signed using an initial signature key of a current owner of the original token, and generating a second signed value of a concatenation of the second hash value and the second verification key and signed using the initial signature key of the current owner of the original token. The method may additionally include sending the non-interactive zero knowledge proof, the first hash value, the first signed value, the first verification key, the second hash value, the second signed value, and the second verification key to an administrator of a blockchain for posting to the blockchain.

The object and advantages of the embodiments will be realized and achieved at least by the elements, features, and combinations particularly pointed out in the claims.

It is to be understood that both the foregoing general description and the following detailed description are merely examples and explanatory and are not restrictive.

### BRIEF DESCRIPTION OF THE DRAWINGS

Example embodiments will be described and explained with additional specificity and detail through the use of the accompanying drawings in which:

FIG. 1 is a diagram illustrating an example system which may utilize a blockchain to verify ownership of an asset;

FIG. 2 is a diagram illustrating an example system which may utilize a blockchain to verify ownership of an asset in which rights associated with ownership may be split;

FIG. 3 illustrates an example flowchart of an example method of issuing a token associated with an owned asset;

FIG. 4 illustrates an example flowchart of an example method of transferring ownership of an asset;

FIG. 5 illustrates an example flowchart of an example method of proving current ownership of an asset to an administrator of a blockchain;

FIG. 6 illustrates an example flowchart of an example method of verifying ownership of an asset;

FIGS. 7A and 7B illustrate an example flowchart of an example method of splitting rights associated with ownership of an asset; and

FIG. 8 illustrates an example computing system.

### DETAILED DESCRIPTION

The present disclosure relates to the use of blockchain technology to verify ownership of an asset. For example, an issuing entity may provide an electronic token associated with ownership to an owner of an asset and may post a hash associated with the token for posting to the blockchain. For example, a county government office may issue a token associated with ownership of real estate. The owner of the asset may be permitted to transfer ownership of the asset without involving or including the issuing entity. For example, the owner may be able to transfer ownership of the real estate to a subsequent owner without involving the county government office. Instead, the original owner may prove current ownership to the blockchain and may post a new entry in a list on the blockchain identifying new ownership of the asset. If a verifier wants to verify whether or not an entity is the owner, the verifier is able to observe the most recent block on the list of the blockchain and compare it to information provided by the current owner (such as via a zero knowledge proof) to verify current ownership. For example, for a bank that wants to verify that the owner of the real estate is in fact the owner, the bank can verify the ownership based on information obtained from the owner and the blockchain without involving the county government office. Additionally, the verification information is in a publicly reliable location such as the blockchain.

In these and other embodiments, a current owner may prove their ownership to an administrator of the blockchain prior to transferring ownership. For example, a non-interactive zero knowledge proof (NIZKP) based on a randomness value associated with the current ownership and the token may be used to prove to the administrator of the blockchain that the user submitting the information is the current owner. Additionally or alternatively, a similar or comparable NIZKP may be used to prove to the potential acquirer of the asset that the user offering to transfer the asset is the current owner of the asset.

In some embodiments, the issuing entity may set up provision for the token to be split based on the rights associated with the token. For example, if the owned asset is a condominium, the issuing entity may permit for the splitting of the token into individual days associated with possession of the condominium (such as a nightly rental). In these and other embodiments, the individual components of the split token may be a faithful decomposition of the original token. After splitting the token, the owner splitting the token may provide information for the blockchain to start new lists on the blockchain, with each sub-token having its own list on the blockchain with transferrable ownership of the sub-token. The list associated with the original token may also be invalidated.

Certain embodiments of the present disclosure may provide improvements over previous iterations of secure communications and ownership validation/verification. For example, embodiments of the present disclosure may provide a more secure interaction between parties by permitting limited exposure of information. In particular, a verifier may be able to verify ownership of an asset in a reliable manner while the verifier does not have to necessarily have access to other information regarding the ownership of the asset. Additionally, the issuing party may not be required to be involved in each successive transfer of ownership and/or splitting of ownership rights of an asset. For example, the issuing entity may be completely offline during subsequent transactions. This may reduce the workload of the issuing entity while also providing privacy from the issuing entity. Additionally, embodiments of the present disclosure permits using blockchain technology to facilitate the security and reliability of the public information that facilitates the verification of ownership and transfer of assets. For example, the actual tokens and/or their properties may remain confidential to the blockchain using randomness values. In some embodiments, a public key infrastructure is not necessary as keys may be generated as transactions come up. In some embodiments, the users and/or tokens across transactions may be unlinkable (e.g., particular users may or may not be traceable to certain transactions and/or tokens). Additionally, one or more embodiments of the present disclosure may facilitate the splitting of tokens and/or associated aspects or rights of ownership of an asset without the involvement of an issuing entity and/or the privacy and security of the blockchain.

One or more example embodiments are explained with reference to the accompanying drawings.

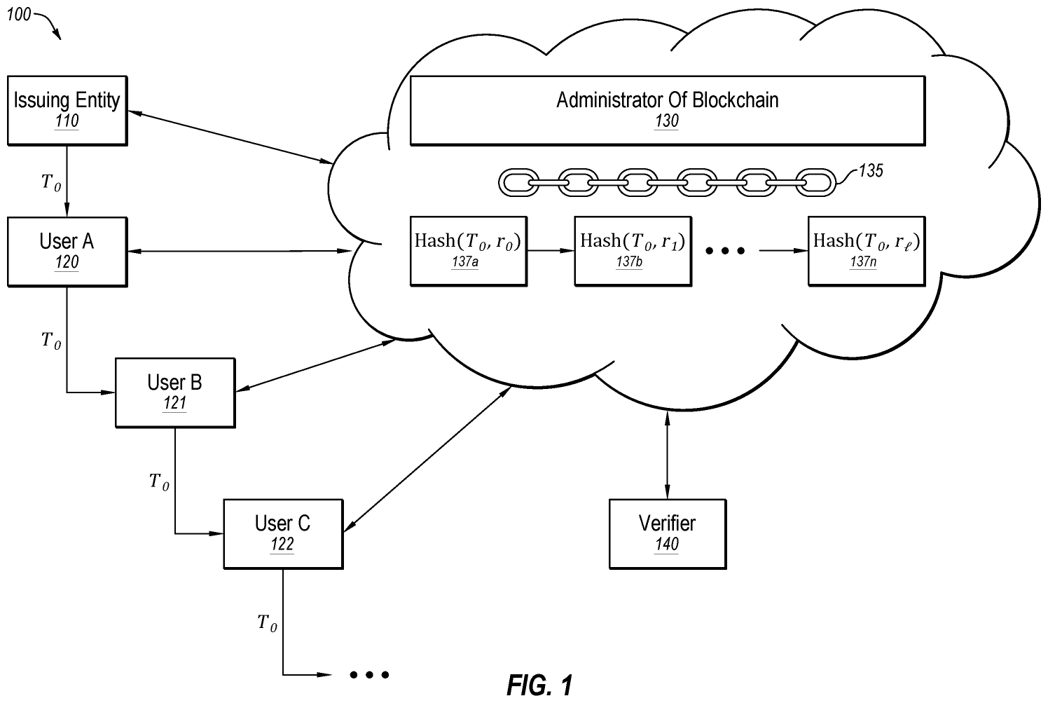

FIG. 1 is a diagram illustrating an example system 100 which may utilize a blockchain 135 to verify ownership of an asset, in accordance with one or more embodiments of the present disclosure. The system 100 may include an issuing entity 110, a user A 120, a user B 121, and a user C 122, an administrator of a blockchain 130, a list of the blockchain 135, and a verifier 140.

The issuing entity 110 may include any trusted authority or entity with authority relative to the asset for which ownership is at issue. For example, if the asset is real estate or real property, the issuing entity 110 may include a county assessor's office, property tax office, records office, etc. As another example, if the asset is a vehicle, the issuing entity 110 may include a state department of motor vehicles (DMV), etc. In these and other embodiments, the issuing entity 110 may be an entity in which it would be cumbersome to have the issuing entity 110 involved with every transfer of ownership of the asset, or every verification of ownership of the asset. Additionally or alternatively, it may be desirable to keep the issuing entity 110 unaware of the transfers of ownership or verification of ownership for privacy reasons.

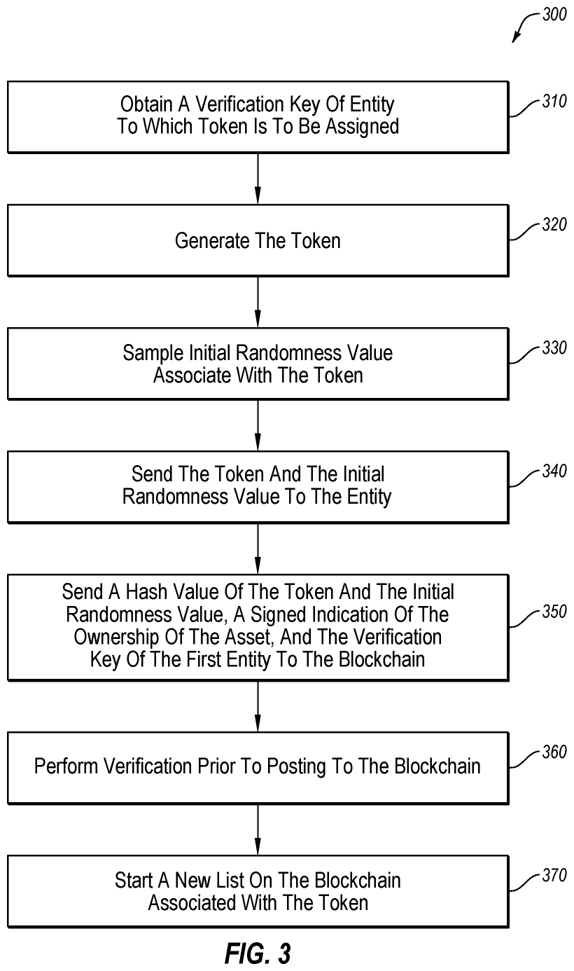

In operation, the issuing entity 110 may be configured to generate a token (T₀) associated with an asset that is owned or is being acquired in an initial transaction by the user A 120. An example of the issuing of the token may be described in greater detail with reference to FIG. 3. The issuing entity 110 may hold a signing/verification key pay (sk_{I}, vk_{I}) where sk_{I} may represent the signature key (the secret component) and vk_{I} may represent the verification key (the public component). The issuing entity may obtain a verification key of the user A 120, where the user A 120 may hold a signing/verification key pair (sk₀, vk₀). The issuing entity 110 may sample an initial randomness value (r₀) and may provide the token (T₀) and the initial randomness value (r₀) to the user A 120.

In some embodiments, the issuing entity 110 may provide information indicative of ownership of the asset associated with the token (T₀) to an administrator of the blockchain 130. For example, the issuing entity 110 may generate a hash value (h) of the token (T₀) and the initial randomness value (r₀) that is provided to the administrator of the blockchain 130. Additionally or alternatively, the issuing entity 110 may generate a signed value (σ) of a combination (e.g., a concatenation) of the hash value (h) and the verification key of the user A 120 (vk₀) that is signed using the signature key of the issuing entity 110 (sk_{I}). Additionally or alternatively, the issuing entity 110 may provide the verification key of the user A 120 (vk₀) to the administrator of the blockchain 130. For example, stated mathematically, h =Hash(T₀, r₀), where Hash may represent a hashing function, and σ=Sign(sk_{I}, h∥vk₀).

The administrator of the blockchain 130 may include one or more entities with authority to post information to the blockchain 135. In some embodiments, the administrator of the blockchain 130 may include multiple entities that follow a protocol such that after a certain number or percentage of administrators verify information, that information is posted to the blockchain 135. In these and other embodiments, one or more of the administrators may store a complete copy of the blockchain 135 such that the blockchain 135 may maintain public integrity.

In some embodiments, the administrator of the blockchain 130 may be configured to verify the information received from the issuing entity 110 prior to posting the information to the blockchain 135. For example, the administrator of the blockchain 130 may verify the signed value relative to the verification key of the issuing entity 110 (vk_{I}) and the concatenation of the hash value and the verification key of the user A 120. For example, stated mathematically, the administrator of the blockchain 130 may perform the operation VerifySign(vk_{I}, σ, h∥vk₀) where VerifySign may be a verification of the signed value relative to the verification keys.

After verification (e.g., if the VerifySign function succeeds), the administrator of the blockchain 130 may post the hash value, the signed value, and/or the verification key of the user A 120 to the blockchain 135 as an initial entry in a new list on the blockchain 135. For example, the values may be posted as a tuple 137a to the blockchain 135. The new list may be associated with the token (T₀). By using the hashed values and the signed values, the list may be associated with the token (T₀) without posting the token (T₀) to the blockchain 135. In this manner, the token itself may be kept secure.

In some embodiments, the administrator of the blockchain 130 may post proof of one or more of the verifications performed by the administrator of the blockchain 130 to the blockchain 135. By posting the verification to the blockchain, the overall integrity of transactions may be more readily confirmed and observed. Additionally or alternatively, the administrator of the blockchain 130 may discard the result of the verifications it has performed after performing the verifications. For example, by doing so, greater privacy may be maintained, and certain aspects of transactions and/or the number of transactions may be better masked.

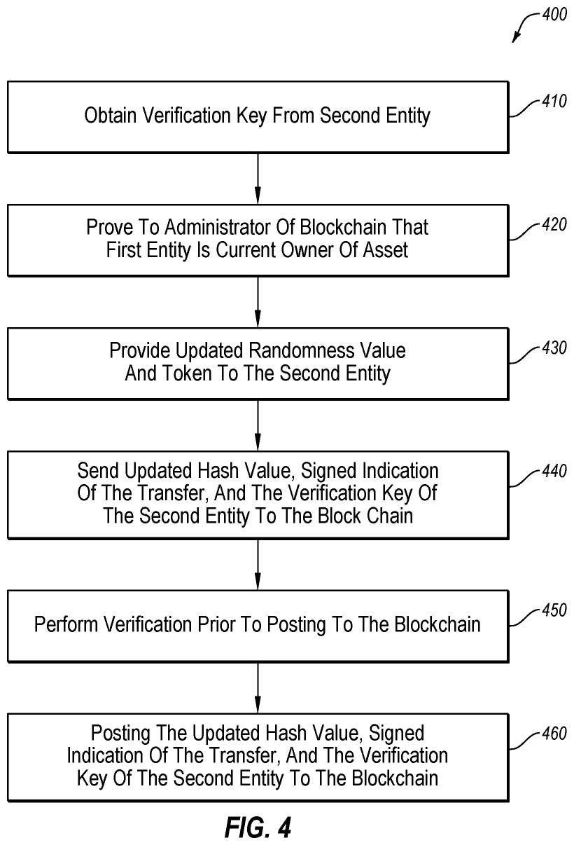

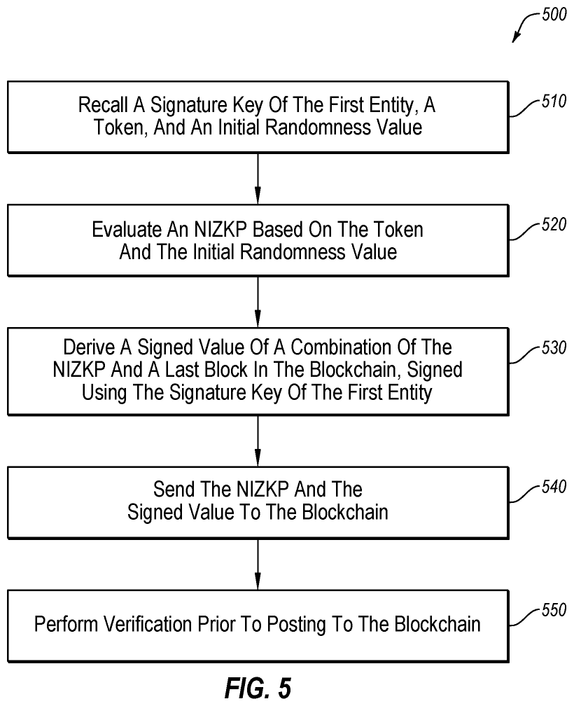

In some embodiments, the user A 120 may desire to transfer the asset to the user B 121. To transfer ownership, the blockchain 135 may be updated to reflect the change in ownership. The user A 120 may prove ownership to the administrator of the blockchain 130 such that the user A 120 is permitted to post updated ownership information to the blockchain 135. An example of transferring ownership as reflected on the blockchain is described with reference to FIG. 4; an example of proving ownership to the administrator of the blockchain is described with reference to FIG. 5.

In some embodiments, to prove that the user A 120 is the current owner of the asset associated with the token (T₀), the user A 120 may recall the signature key (sk₀), the token (T), and the initial randomness value (r₀) from storage. The user A 120 may generate a proof to provide to the administrator of the blockchain 130 that the user A 120 is the current owner of the token (T). For example, the user A 120 may generate a zero knowledge proof (such as an NIZK proof) of knowledge of T, and r. Stated mathematically, the user A 120 may generate the NIZK proof (π) of T, r such that [symbol] =Hash(T, [symbol] ) where [symbol] may correspond to the last hash value on the blockchain 135 and [symbol] may correspond to the latest randomness value on the blockchain 135. The user A 120 may additionally generate a signed value (σ′) associated with the NIZK proof (π), and the user A 120 may provide the signed value (σ′) and the NIZK proof (π) to the administrator of the blockchain 130 to prove ownership of the token (T). For example, mathematically deriving the signed value (σ′) may include the evaluation of σ′=Sign(sk₀, s|π) where σ′ may be the signed value associated with the proof, Sign may be an encrypting/signing function in which a value is signed/encrypted using a signature key, sk₀ may represent the signature key of the user A 120, s may represent a hash ( [symbol] ) of the last block in the list of the blockchain 135 associated with the token (T), and π may represent the proof of knowledge.

After receiving the proof and/or the signed value from the user A 120, the administrator of the blockchain 130 may verify the proof of knowledge (π) of the user A 120 to validate that the user A 120 is the current owner of the asset associated with the token (T₀). Additionally or alternatively, the administrator of the blockchain may verify the signed value. For example, stated mathematically, the administrator of the blockchain 130 may evaluate VerifySign(vk₀, σ′, s|π). Based on the proof of knowledge (π) and/or the VerifySign succeeding, the administrator of the blockchain 130 may validate that the user A 120 is the current owner of the asset associated with the token (T₀).

In some embodiments, the administrator of the blockchain 130 may permit the user A 120 to provide information for a new block on the blockchain 135 identifying new ownership of the asset associated with the token (T₀). For example, in transferring ownership to the user B 121, the user A 120 may obtain the verification key (vk₁) of the user B 121. The user A 120 may sample a second randomness value (r₁) and evaluate a second hash value (h′) of the token (T₀) and the second randomness value (r₁). The user A 120 may generate a second signed value (σ″) of a combination (e.g., a concatenation) of the second hash value and the verification key of the user B 121 that is signed using the signature key of the user A 120. For example, stated mathematically, the user A 120 may evaluate h′=Hash(T₀, r₁) and may evaluate σ″=Sign(sk₀, h′∥vk₁).

After being verified as the current owner, the user A 120 may provide the administrator of the blockchain 130 with updated ownership information associated with the user B 121. For example, the user A 120 may provide the second hash value (h′), the second signed value (σ″), and the verification key of the user B 121 as the new ownership information to be posted to the blockchain 135 as the new latest ownership information associated with the token (T₀). The administrator of the blockchain 130 may verify that user A 120 is the current owner (as described above), and may verify the signature of the newly submitted ownership information. For example, the administrator of the blockchain 130 may evaluate VerifySign(vk₀, σ′, h′∥vk₁) and based on the evaluation succeeding, may append a tuple of (h′, σ″, vk₁) to the blockchain 135 as the tuple 137b.

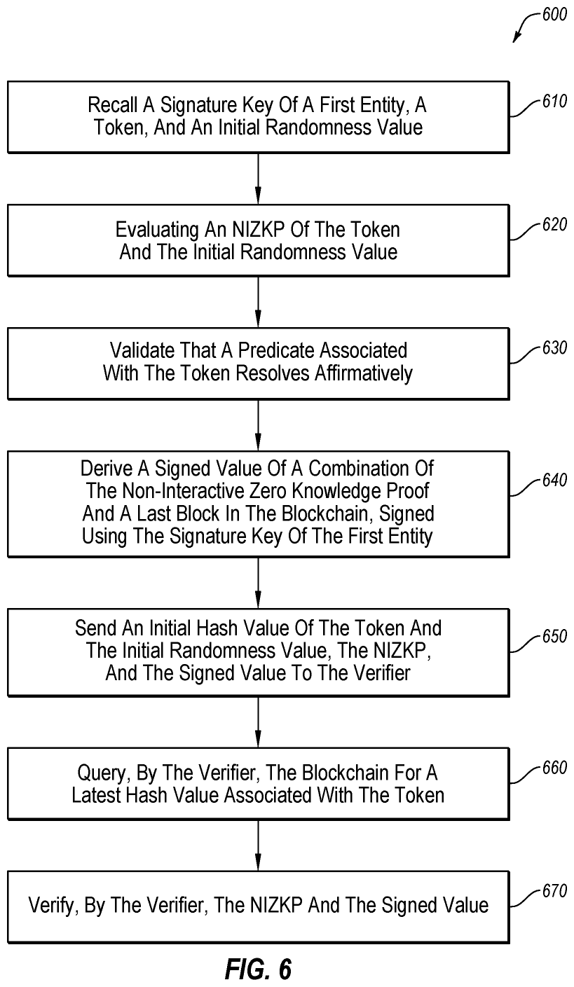

A similar process may follow if the user B 121 seeks to transfer the ownership of the asset and the associated token (T₀) to the user C 122. For example, the user B 121 may prove to the administrator of the blockchain 130 that the user B 121 is the current owner of the token (T₀) and may provide updated ownership information identifying the user C 122 as the new owner (e.g., using the verification signature of the user C 122 and providing the user C 122 with the newly sampled randomness value). In these and other embodiments, it is the user with the information associated with the latest posting to the blockchain 135 (e.g., with the tuple 137n) that may be verified as the current owner. An example of validating ownership to a verifier may be described with greater detail in reference to FIG. 6.

In some embodiments, the verifier 140 may seek to validate that a user purporting to be the current owner of the asset associated with the token (T₀) is the current owner. For example, the user B 121 may seek to utilize real estate as collateral for a loan and a bank may seek to validate that user B 121 is the owner. The verifier 140 may include any entity, user, device, system, etc. seeking to validate that a party has knowledge of one or more properties associated with the token (T₀), such as proof of ownership by showing knowledge of the randomness value and the token. The one or more properties may be proved using a predicate (P), which may represent a function that operates on the token to yield a true or false (e.g., 1 or 0) result. In a simplest form, the predicate may be set as 1 or true by the current owner of the token by default, indicating that as long as the token and/or randomness value corresponds to the latest posting to the list of the blockchain 135, the verification will be confirmed. Additionally or alternatively, another property of the token (T₀) and/or the associated asset may be used. In such a manner, a specific aspect of the token (To₀) and/or the associated asset may be verified. For example, the predicate (P) may be used to prove that a real estate property has water rights, or that a condominium has pool access, etc. Additionally or alternatively, a limited subset of information may be disclosed to the verifier 140, for example, information based on the predicate without any additional information, providing increased privacy.

The process of validating ownership to the verifier 140 by a user (e.g., the user B 121) may be a similar or comparable process to that used to prove ownership to the administrator of the blockchain 130, with some minor variation. In some embodiments, the verifier 140 may provide the user B 121 with a random value (v) to facilitate verification. By way of example, the user B 121 may generate a proof of knowledge of the token (T₀) and the latest randomness value (r₁ in this example) and the predicate. The user B 121 may additionally generate an additional signed value associated with the proof of knowledge and the random value (v) from the verifier 140. For example, stated mathematically, the user B 121 may generate a NIZK proof (π) of the token (T₀) and the randomness value (r₁) such that h′=Hash(T₀, r₁) and P(T₀)=1, where P( . . . ) represents the predicate function. As another example, stated mathematically, the user B 121 may generate the additional signed value σ′″=Sign(sk₀, v|π). In these and other embodiments, the user B 121 may provide the hash value h′, the proof of knowledge (π), and the additional signed value (σ′″) to the verifier 140.

To validate ownership, the verifier 140 may use the hash value h′ to query the blockchain 135 for the latest hash value on the blockchain 135. If the query fails (e.g., because the user B 121 already transferred the asset and associated token to the user C 122), the verifier 140 may abort the validation. If the query succeeds, the verifier 140 may verify the proof of knowledge (π) of the user B 121. Additionally or alternatively, the verifier 140 may verify the signed value. For example, stated mathematically, the verifier 140 may evaluate VerifySign(vk₁, σ′″, v|π). Based on the proof of knowledge (π) and/or the VerifySign succeeding, the verifier 140 may validate that the user B 121 is the owner of the asset associated with the token (T₀) and/or may validate that the predicate P( . . . ) is verified.

Modifications, additions, or omissions may be made to the system 100 without departing from the scope of the disclosure. For example, the designations of different elements in the manner described is meant to help explain concepts described herein and is not limiting. Further, the system 100 may include any number of other elements or may be implemented within other systems or contexts than those described. For example, the system 100 may include any number of users between which the token may be passed. As another example, there may be any number of administrators providing input to, and/or controlling the blockchain 135.

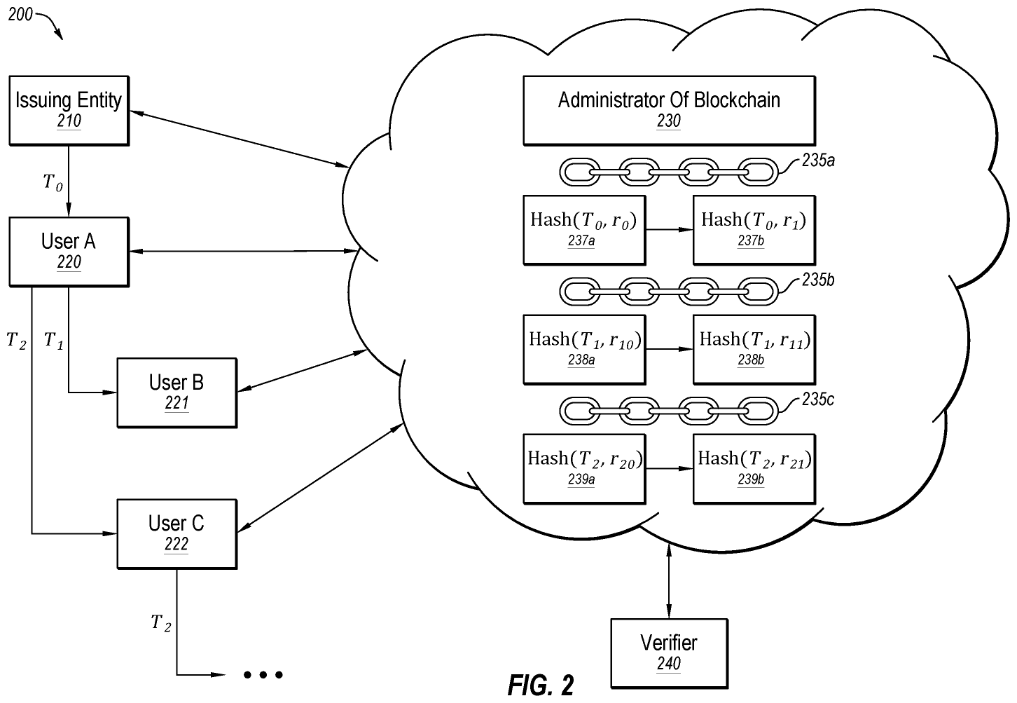

FIG. 2 is a diagram illustrating an example system 200 which may utilize a blockchain 235 to verify ownership of an asset in which rights associated with ownership may be split, in accordance with one or more embodiment of the present disclosure. The system 200 may be similar or comparable to the system 100 of FIG. 1. For example, the issuing entity 210 may be similar or comparable to the issuing entity 110 of FIG. 1; the user A 220, user B 221, and user C 222 may be similar or comparable to the user A 120, user B 121, and user C 122 of FIG. 1; the administrator of the blockchain 230 may be similar or comparable to the administrator of the blockchain 130 of FIG. 1; the blockchain 235 may be similar or comparable to the blockchain 135 of FIG. 1; and/or the verifier 240 may be similar or comparable to the verifier 140 of FIG. 1.

In operation, the issuing entity 210 may issue the token T₀ in a similar or comparable manner to that described with reference to FIG. 1. To accommodate the splitting of the token, the issuing entity 210 may provide rules, policies, or other information directing the manner in which the token (T₀) may be divided. For example, for real estate, the information may describe which rights of ownership may be divided from each other (e.g., access to a community pool, access to a dwelling, access to a garage, etc.), periods of time within which the rights may be separated (e.g., weekly, nightly, and/or hourly occupation, etc.), or other manners in which the rights may be divided. As another example, for ownership of a vehicle like an electric car, the information may describe periods of time within which the rights may be separated (e.g., minutes or hours during a day, days, or weeks of use, etc.), portions of rights that may be divided (e.g., occupancy of a front seat, occupancy of a back seat, etc.), etc. In these and other embodiments, the information regarding the splitting or dividing of the token may include the smallest unit of time for which divisible possession or use is desirable (such as nightly for an apartment rental, or hourly for vehicle use, etc.).

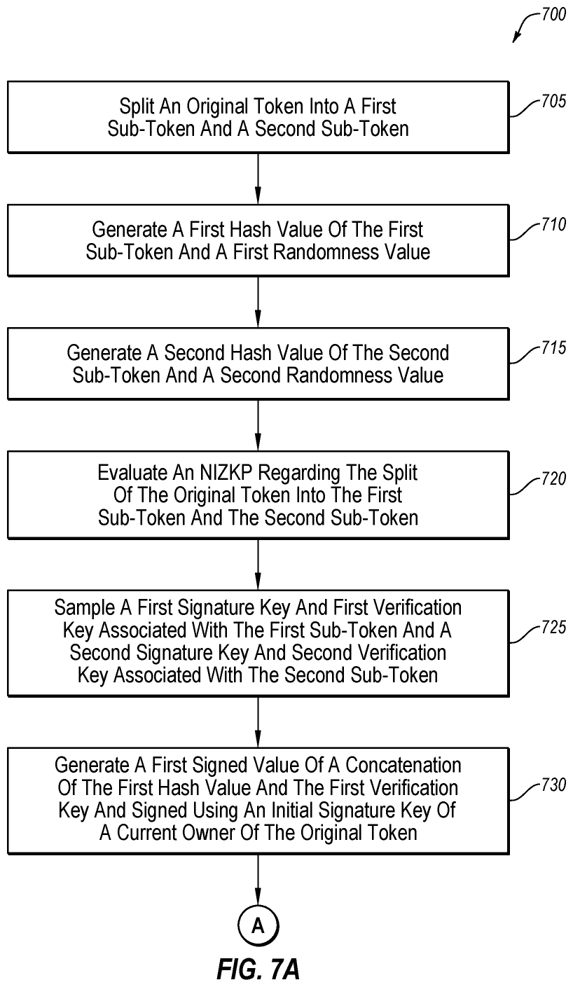

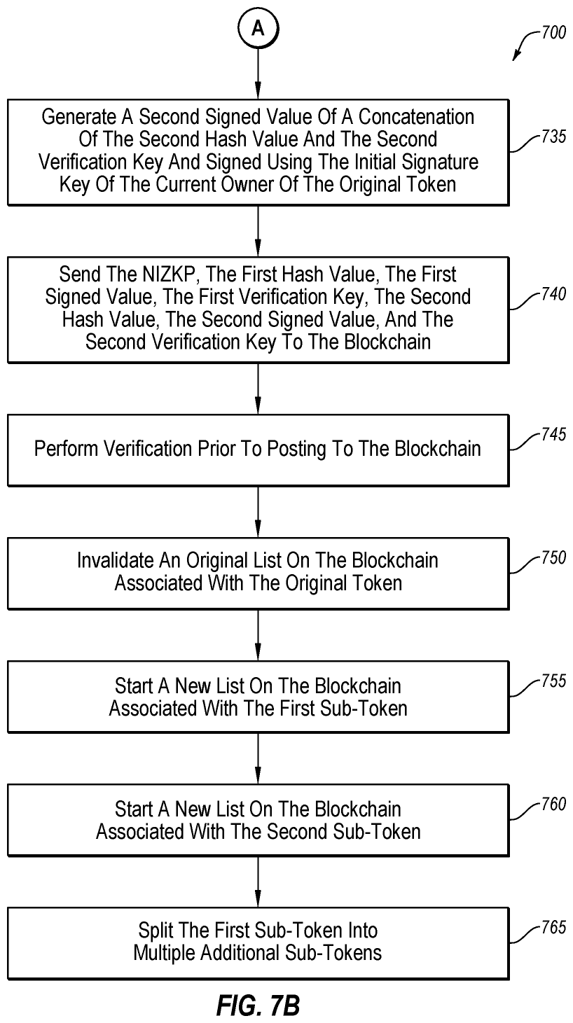

In some embodiments, the user A 220 may desire to split rights of ownership of the asset associated with the token (T₀) into two separate sub-tokens (T₁) and (T₂). For example, the user A 220 may desire to separate out one week of occupancy of his condominium (T₂) while remaining occupancy for the remainder of the time (T₁). The combination of the two sub-tokens (T₁) and (T₂) may represent all of the rights of ownership of the asset associated with the token (T₀), or stated another way, the sub-tokens (T₁) and (T₂) may represent a faithful decomposition of the original token (T₀). An example of splitting the token (T₀) into the sub-tokens (T₁) and (T₂) may be described with reference to FIGS. 7A and 7B.

In some embodiments, to split the token (T₀), the user A 220 may be conceptually similar to the user A 220 acting as the issuing entity to issue two new sub-tokens (T₁) and (T₂). For example, the user A 220 may sample two new randomness values (r₁₀, r₂₀) and generate two new tokens (T₁, T₂). The user A 220 may derive the hashes h₁=Hash(T₁, r₁₀) and h₂=Hash(T₂, r₂₀). The user A 220 may prove to the administrator of the blockchain 230 that the user A 220 is the current owner of the latest block in the blockchain 235 (e.g., is the owner associated with the tuple 237b).

In some embodiments, the user A 220 may generate a proof of knowledge on the last hash ( [symbol] ) value associated with the original token (T₀) and the two new hash values. For example, the user A 220 may generate a NIZK on the statement “There exists T₀, r₀, r₁₀, r₂₀: [symbol] =Hash(T₀, r₀) and h₁=Hash(T₁, r₁₀) and h₂=Hash(T₂, r₂₀) and (T₁, T₂) is a faithful decomposition of T₀.”

In some embodiments, the user A 220 may generate a signed value for each of the generated sub-tokens using a new signature key pair for each of the new sub-tokens and signed using a signature key of the user A 220 associated with the original token (T₀). For example, the user A 220 may sample (sk₁₀, vk₁₀) and (sk₂₀, vk₂₀) as being associated with the new sub-tokens (T₁) and (T₂), respectively. An example of generating the signed values, stated mathematically, may include σ₁=Sign(sk, h₁∥vk₁₀) and σ₂=Sign(sk, h₂∥vk₂₀) where σ₁ and σ₂ may represent the signed values, and sk may represent the signature key of the user A 220 associated with the original token (T₀). In some embodiments, the user A 220 may retain ownership of one of the tokens, and may utilize the same signature key for a retained sub-token (e.g., the user A 220 may maintain sk¹⁰ as the same value as sk).

In some embodiments, the user A 220 may provide the owners of the sub-tokens with the signature keys generated by the user A 220 as associated with the new sub-tokens. For example, following the example illustrated in FIG. 2 when transferring the token T₁ to the user B 221 and the token T₂ to the user C 222, the user A 220 may provide the user B 221 with the token T₁ along with the randomness value r₁₀ and the signature key sk¹⁰. Similarly, the user A 220 may provide the user C 222 with the token T₂ along with the randomness value r₂₀ and the signature key sk₂₀.

The user A 220 may provide the administrator of the blockchain 230 with the updated information regarding ownership. For example, the user A 220 may send the tuples (h₁, σ₁, vk₁₀) and (h₂, σ₂, vk₂₀) to the administrator of the blockchain 230. The administrator of the blockchain 230 may verify the signature values and the proof of knowledge from the user A 220. Based on both being verified, the administrator of the blockchain 230 may generate two new lists on the blockchain 235 associated with each of the two new sub-tokens (T₁) and (T₂). For example, the blockchain 235 may include a first list 235b with an initial tuple 238a and a second list 235c with an initial tuple 239a. In some embodiments, the administrator of the blockchain 230 may cap, cancel, block, or otherwise prevent any further additions to the original list 235a of the blockchain 235.

Each of the sub-tokens (T₁) and (T₂) may be independently transferred and/or verified as described above with reference to FIG. 1. Additionally or alternatively, if the information regarding the tokens indicates that the tokens may be further subdivided, a later owner of the sub-tokens may further split one or more of the tokens. In some embodiments, a given token may be split into multiple tokens and is not limited to being split into two tokens as illustrated in the example of FIG. 2. Rather, FIG. 2 serves as an illustrative example of the principles of the present disclosure.

Modifications, additions, or omissions may be made to the system 200 without departing from the scope of the disclosure. For example, the designations of different elements in the manner described is meant to help explain concepts described herein and is not limiting. Further, the system 200 may include any number of other elements or may be implemented within other systems or contexts than those described. For example, the system 200 may include any number of users between which the token may be split. As another example, there may be any number of administrators providing input to, and/or controlling the blockchain 235.

FIG. 3 illustrates an example flowchart of an example method 300 of issuing a token associated with an owned asset, in accordance with one or more embodiments of the present disclosure. One or more operations of the method 300 may be performed by a system or device, or combinations thereof, such as the system 100, the issuing entity 110, the user A 120, the user B 121, the user C 122, the administrator of the blockchain 130, and/or the verifier 140 of FIG. 1 and/or the system 100, the issuing entity 210, the user A 220, the user B 221, the user C 222, the administrator of the blockchain 230, and/or the verifier 240 of FIG. 2. Although illustrated as discrete blocks, various blocks of the method 300 may be divided into additional blocks, combined into fewer blocks, or eliminated, depending on the desired implementation.

At block 310, a verification key of an entity to which a token is to be assigned is obtained. For example, an issuing entity may receive the verification key from a user who is the owner of an asset. In these and other embodiments, the entity that is the owner may derive a pair of signature keys (e.g., (sk₀, vk₀)), and the verification key of the pair (vk₀) may be provided to the issuing entity.

At block 320, a token may be generated. For example, the issuing entity may generate the token (T₀) associated with the asset owned by the entity/user.

At block 330, an initial randomness value associated with the token may be sampled. For example, the issuing entity may generate the initial randomness value (r₀) by sampling the value from the set of real numbers.

At block 340, the token and the initial randomness value may be sent to the entity. For example, the issuing entity may provide the token (T₀) and the initial randomness value (r₀) to the user that is the owner of the asset for which the token is issued.

At block 350, a hash value of the token and the initial randomness value, a signed indication of the ownership of the asset, and the verification key of the first entity may be sent to the blockchain. For example, the issuing entity may generate the hashed value (e.g., h=Hash(T, r)) and the signed indication of the ownership of the asset (e.g., σ=Sign(sk_{I},h∥vk₀)) to provide to the administrator of the blockchain along with the verification key of the first entity.

At block 360, verification may be performed on the received information prior to posting the information to the blockchain. For example, an administrator of the blockchain may verify the signed value prior to posting the tuple of the hashed value, the signed indication of ownership, and the verification key of the first entity to the blockchain.

At block 370, a new list may be started on the blockchain as associated with the token. For example, the new list may reflect a history of ownership of the asset as identified by holder of the token, with the last posting in the new list reflecting the current owner of the token (and by implication, the associated asset).

Modifications, additions, or omissions may be made to the method 300 without departing from the scope of the disclosure. For example, the operations of the method 300 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

FIG. 4 illustrates an example flowchart of an example method 400 of transferring ownership of an asset from a first entity to a second entity, in accordance with one or more embodiments of the present disclosure. One or more operations of the method 400 may be performed by a system or device, or combinations thereof, such as the system 100, the issuing entity 110, the user A 120, the user B 121, the user C 122, the administrator of the blockchain 130, and/or the verifier 140 of FIG. 1 and/or the system 100, the issuing entity 210, the user A 220, the user B 221, the user C 222, the administrator of the blockchain 230, and/or the verifier 240 of FIG. 2. Although illustrated as discrete blocks, various blocks of the method 400 may be divided into additional blocks, combined into fewer blocks, or eliminated, depending on the desired implementation.

At block 410, a verification key may be obtained from a second entity. For example, a first user that owns an asset and is transferring an asset to a second user may obtain the verification key of the second user.

At block 420, the first entity may prove to an administrator of the blockchain that the first entity is the current owner of the asset. For example, the first user may generate a NIZK proof of knowledge of the token and the randomness value associated with the last entry in the blockchain.

At block 430, the first entity may provide an updated randomness value and the token to the second entity. For example, the first entity may sample a new random value as the updated randomness value to be associated with the token and the new owner, the second entity.

At block 440, the first entity may send an updated hash value, a signed verification of the transfer, and the verification of the second key to the administrator of the blockchain. For example, the first entity may derive a hash value of the token and the updated randomness value as the updated hash value. Additionally or alternatively, the signed verification of the transfer may include a combination (e.g., a concatenation) of the updated hash value and the verification key of the second entity (e.g., the new owner), signed by the signature key of the first entity (e.g., the original owner).

In some embodiments, in addition to or alternatively to the proof at the block 420, the first entity may provide a proof of knowledge of the token, the initial randomness value (or the most recently-posted randomness value to the block chain), and the updated randomness value such that the latest hash posted on the blockchain is the same as the hash provided by the first entity (e.g., the hash of the token and the initial randomness value (or the most recently-posted randomness value to the block chain)) as well as the new hash value of the token and the updated randomness value. In proving the knowledge, the first entity may provide the proof as a function of the latest hash in the blockchain as signed by the signature key of the first entity.

At block 450, the administrator of the blockchain may perform verification of one or more pieces of information prior to posting a new block to the blockchain. For example, the administrator of the blockchain may verify that the first entity has knowledge of the token and initial randomness value by verifying the proof of knowledge of the block 420. As another example, the administrator of the block chain may verify the proof of knowledge of the block 440. As a further example, the administrator of the blockchain may verify the signed verification of the transfer of ownership of the block 440.

At block 460, the administrator of the blockchain may post the updated hash value, the signed indication of the transfer, and/or the verification key of the second entity to the blockchain. For example, a tuple of the updated hash value, the signed indication of the transfer, and/or the verification key of the second entity may be posted as a new latest block in the list on the blockchain associated with the token. By adding the new block, the ownership information reflects the new owner as the last block in the list is now associated with the verification key of the second entity and the updated randomness value that is in possession of the second entity.

Modifications, additions, or omissions may be made to the method 400 without departing from the scope of the disclosure. For example, the operations of the method 400 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

FIG. 5 illustrates an example flowchart of an example method 500 of proving current ownership of an asset to an administrator of a blockchain, in accordance with one or more embodiments of the present disclosure. For example, the method 500 may be an example of or an expansion of the block 420 of FIG. 4. One or more operations of the method 500 may be performed by a system or device, or combinations thereof, such as the system 100, the issuing entity 110, the user A 120, the user B 121, the user C 122, the administrator of the blockchain 130, and/or the verifier 140 of FIG. 1 and/or the system 100, the issuing entity 210, the user A 220, the user B 221, the user C 222, the administrator of the blockchain 230, and/or the verifier 240 of FIG. 2. Although illustrated as discrete blocks, various blocks of the method 500 may be divided into additional blocks, combined into fewer blocks, or eliminated, depending on the desired implementation.

At block 510, a signature key of the first entity, a token, and an initial randomness value may be recalled from a storage location by the first entity. For example, the first entity may store its own signature key, the token, and the initial randomness value to be used to prove ownership of the asset associated with the token and/or to convey the asset to another entity.

At block 520, a non-interactive zero knowledge proof (NIZKP) may be evaluated based on the token and the initial randomness value. For example, the NIZKP may prove knowledge of the token (T) and the initial randomness value (r) such that a hash of the two matches the hash of the latest entry on the blockchain.

At block 530, a signed value of a combination of the NIZKP of the block 520 and a last block in the blockchain may be derived and signed using the signature key of the first entity. For example, the first entity may derive the signed value by performing the operation σ′=Sign(sk₀, s|π).

At block 540, the NIZKP of the block 520 and the signed value of the block 530 may be sent to the administrator of the blockchain.

At block 550, a verification may be performed on the information provided to the administrator of the blockchain prior to posting to the blockchain. For example, the administrator of the blockchain may verify the NIZKP evaluates to an affirmative value. Based on the information being verified, e.g., the NIZKP and signed value indicating the first entity has knowledge of the token and the initial randomness value, the administrator of the blockchain may identify the first entity as being the current owner of the token and the associated asset.

In some embodiments, the administrator of the blockchain may post the verification itself, the NIZKP, or other information related to the verification to the blockchain such that the verification is observable and checkable upon the blockchain. Additionally or alternatively, the administrator of the blockchain may discard the results and/or other information related to performing the verification after the verification has been performed.

Modifications, additions, or omissions may be made to the method 500 without departing from the scope of the disclosure. For example, the operations of the method 500 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

FIG. 6 illustrates an example flowchart of an example method 600 of verifying ownership of an asset, in accordance with one or more embodiments of the present disclosure. One or more operations of the method 600 may be performed by a system or device, or combinations thereof, such as the system 100, the issuing entity 110, the user A 120, the user B 121, the user C 122, the administrator of the blockchain 130, and/or the verifier 140 of FIG. 1 and/or the system 100, the issuing entity 210, the user A 220, the user B 221, the user C 222, the administrator of the blockchain 230, and/or the verifier 240 of FIG. 2. Although illustrated as discrete blocks, various blocks of the method 600 may be divided into additional blocks, combined into fewer blocks, or eliminated, depending on the desired implementation.

At block 610, a signing key of a first entity, a token, and an initial randomness value may be recalled from storage. For example, the first entity may store one or more of such values to facilitate verification of ownership.

At block 620, an NIZKP of the token and the initial randomness value may be evaluated. For example, the first entity may evaluate (π) in the NIZKP that the first entity has knowledge of T, r such that [symbol] =Hash(T, r).

At block 630, it may be validated that a predicate associated with the token resolves affirmatively. For example, the NIZKP of the block 620 as derived by the first entity may include proof that a predicate associated with the token is also provably true. For example, the NIZKP may include proof that P(T)=1.

At block 640, a signed value may be derived that includes a combination of the non-interactive zero knowledge proof (NIZKP) of the block 620 and/or 630, a last block in the blockchain, and/or a randomly sampled value provided by the verifier. In these and other embodiments, the signed value may be signed using the signature key of the first entity. For example, the first entity may receive a randomly sampled value from the verifier (v) that may be used in generating the signed value. For example, stated mathematically, the first entity may generate the signed value σ′″=Sign(sk₀, v|π).

At block 650, the first entity may send an initial hash value of the token and the initial randomness value, the NIZKP, and the signed value to the verifier.

At block 660, the verifier may query the blockchain for a latest hash value associated with the token. For example, the verifier may use the initial hash value received from the first entity to query the blockchain 135 for the latest hash value on the blockchain 135. If the query fails, the verifier may abort the validation.

At block 670, the verifier may verify the proof of knowledge (e.g., the NIZKP of the blocks 620 and/or 630) and/or the signed value. For example, stated mathematically, the verifier may evaluate VerifySign(vk₁,σ′″,v|π). Based on the proof of knowledge (e.g., π) and/or the VerifySign succeeding, the verifier may validate that the first entity is the owner of the asset associated with the token (To) and/or may validate that the predicate of the block 630 is verified.

Modifications, additions, or omissions may be made to the method 600 without departing from the scope of the disclosure. For example, the operations of the method 600 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

FIGS. 7A and 7B illustrate an example flowchart of an example method 700 of splitting rights associated with ownership of an asset, in accordance with one or more embodiments of the present disclosure. One or more operations of the method 700 may be performed by a system or device, or combinations thereof, such as the system 100, the issuing entity 110, the user A 120, the user B 121, the user C 122, the administrator of the blockchain 130, and/or the verifier 140 of FIG. 1 and/or the system 100, the issuing entity 210, the user A 220, the user B 221, the user C 222, the administrator of the blockchain 230, and/or the verifier 240 of FIG. 2. Although illustrated as discrete blocks, various blocks of the method 700 may be divided into additional blocks, combined into fewer blocks, or eliminated, depending on the desired implementation.

At block 705, an original token may be split into a first sub-token and a second sub-token. For example, a first user that owns a token may split the original token into the sub-tokens based on information, rules, policies, etc. promulgated by an issuing entity that issued the original token (or the original predecessor to the original token).

At block 710, a first hash value may be generated that hashes a combination (e.g., a concatenation) of the first sub-token and a first randomness value. For example, the first user may sample the first randomness value as being associated with the first sub-token.

At block 715, a second hash value may be generated that hashes a combination (e.g., a concatenation) of the second sub-token and a second randomness value. For example, the first user may sample the second randomness value as being associated with the second sub-token.

At block 720, a proof of knowledge (e.g., an NIZKP) may be evaluated regarding the split of the original token into the first sub-token and the second sub-token. For example, the NIZKP may prove that the first sub-token and the second sub-token are a faithful decomposition of the original token.

At block 725, a first signature key and first verification key associated with the first sub-token may be sampled by the first user. Additionally or alternatively, a second signature key and second verification key associated with the second sub-token may be sampled by the first user.

At block 730, a first signed value may be generated of a concatenation of the first hash value and the first verification key that is signed using an initial signature key of a current owner of the original token (e.g., the first user).

Turning to the FIG. 7B, at block 735, a second signed value may be generated of a concatenation of the second hash value and the second verification key that is signed using the initial signature key of the current owner of the original token (e.g., the first user).

At block 740, the NIZKP of the block 720, the first hash value of the block 710, the first signed value of the block 730, the first verification key of the block 725, the second hash value of the block 715, the second signed value of the 735, and the second verification key of the block 725 may be sent to an administrator of the blockchain. For example, a proof of ownership and/or information for new lists for split ownership may be provided to the administrator of the blockchain for posting to the blockchain.

At block 745, verification may be performed by the administrator of the blockchain prior to posting one or more pieces of the information of the block 740 to the blockchain. For example, the administrator may verify that the first user is the current owner of the token. As another example, the administrator of the blockchain may verify that the first and/or second signed values are properly signed and/or that the NIZKP evaluate affirmatively.

At block 750, an original list on the blockchain associated with the original token may be invalidated. For example, a capping entry may be placed on the original list on the blockchain. As another example, any other notification or posting that may signify that the original list is no longer viable or reflective of current ownership of the token may be used.

At block 755, a new list may be started on the blockchain associated with the first sub-token. For example, the new list associated with the first sub-token may post a tuple of the first hashed value, the first signed value, and the first verification key.

At block 760, another new list may be started on the blockchain associated with the second sub-token. For example, the new list associated with the second sub-token may post a tuple of the second hashed value, the second signed value, and the second verification key.

At block 765, the first sub-token may be split into multiple additional sub-tokens. For example, the first sub-token may be split into fourth, fifth, and sixth sub-tokens consistent with the information, rules, policies, etc. promulgated by the issuing entity. After splitting the first sub-token, the invalidation of the new list associated with the first sub-token and the generation of new lists associated with the fourth, fifth, and sixth sub-tokens may follow similar or comparable operations to those described above with reference to splitting the original token into the first and second sub-tokens.

Additionally or alternatively, verification of ownership and/or transference of the first sub-token and/or the second sub-token may occur in a similar manner described in the present disclosure, such as in FIGS. 3-6.

Modifications, additions, or omissions may be made to the method 700 without departing from the scope of the disclosure. For example, the operations of the method 700 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

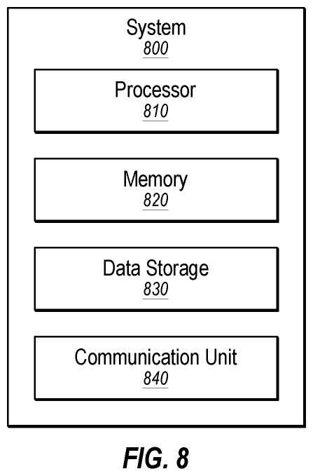

FIG. 8 illustrates an example computing system 800, according to at least one embodiment described in the present disclosure. The computing system 800 may include a processor 810, a memory 820, a data storage 830, and/or a communication unit 840, which all may be communicatively coupled. Any or all of the system 100 of FIG. 1 and/or 200 of FIG. 2 may be implemented as a computing system consistent with the computing system 800, including the issuing entity 110, the user A 120, the user B 121, the user C 122, the administrator of the blockchain 130, and/or the verifier 140 of FIG. 1 and/or the issuing entity 210, the user A 220, the user B 221, the user C 222, the administrator of the blockchain 230, and/or the verifier 240 of FIG. 2.

Generally, the processor 810 may include any computer, computing entity, or processing device including various computer hardware or software modules and may be configured to execute instructions stored on any applicable computer-readable storage media. For example, the processor 810 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 8, it is understood that the processor 810 may include any number of processors distributed across any number of network or physical locations that are configured to perform individually or collectively any number of operations described in the present disclosure. In some embodiments, the processor 810 may interpret and/or execute program instructions and/or process data stored in the memory 820, the data storage 830, or the memory 820 and the data storage 830. In some embodiments, the processor 810 may fetch program instructions from the data storage 830 and load the program instructions into the memory 820.

After the program instructions are loaded into the memory 820, the processor 810 may execute the program instructions, such as instructions to perform any of the methods 300, 400, 500, 600, and/or 700 of FIGS. 3-7B, respectively. For example, the processor 810 may obtain instructions regarding issuing a token associated with an asset, verifying ownership of the token, posting information to the blockchain, splitting the token, etc.

The memory 820 and the data storage 830 may include computer-readable storage media or one or more computer-readable storage mediums for carrying or having computer-executable instructions or data structures stored thereon. Such computer-readable storage media may be any available media that may be accessed by a computer, such as the processor 810. For example, the memory 820 and/or the data storage 830 may store a complete copy of a blockchain (such as the blockchain 135 of FIG. 1). In some embodiments, the computing system 800 may or may not include either of the memory 820 and the data storage 830.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures. Combinations of the above may also be included within the scope of computer-readable storage media. Computer-executable instructions may include, for example, instructions and data configured to cause the processor 810 to perform a certain operation or group of operations.

The communication unit 840 may include any component, device, system, or combination thereof that is configured to transmit or receive information over a network. In some embodiments, the communication unit 840 may communicate with other devices at other locations, the same location, or even other components within the same system. For example, the communication unit 840 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 840 may permit data to be exchanged with a network and/or any other devices or systems described in the present disclosure. For example, the communication unit 840 may allow the system 800 to communicate with other systems, such as computing devices and/or other networks.

One skill in the art, after reviewing this disclosure, may recognize that modifications, additions, or omissions may be made to the system 800 without departing from the scope of the present disclosure. For example, the system 800 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method comprising:
splitting an original token into a first sub-token and a second sub-token;
generating a first hash value of the first sub-token and a first randomness value;
generating a second hash value of the second sub-token and a second randomness value;
evaluating a non-interactive zero knowledge proof regarding the split of the original token into the first sub-token and the second sub-token;
sampling a first signature key and first verification key associated with the first sub-token and a second signature key and second verification key associated with the second sub-token;
generating a first signed value of a concatenation of the first hash value and the first verification key and signed using an initial signature key of a current owner of the original token;
generating a second signed value of a concatenation of the second hash value and the second verification key and signed using the initial signature key of the current owner of the original token; and
sending the non-interactive zero knowledge proof, the first hash value, the first signed value, the first verification key, the second hash value, the second signed value, and the second verification key to an administrator of a blockchain for posting to the blockchain.

2. The method of claim 1, wherein the non-interactive zero knowledge proof is based on an initial hash of the original token and an initial randomness value, the first hash value, and the second hash value.

3. The method of claim 1, wherein the first sub-token and the second sub-token are a faithful decomposition of the original token.

4. The method of claim 1, wherein the original token includes information from an issuer regarding a manner in which the original token may be split.

5. The method of claim 4, wherein the information includes at least one of a unit of time by which the original token is divisible, and a subset of rights associated with ownership of an asset associated with the original token that are divisible from a remainder of the rights associated with ownership of the asset.

6. The method of claim 1, further comprising verifying that the blockchain includes an invalidation of an original list associated with the original token and the creation of a first new list associated with the firs sub-token and a second new list associated with the second sub-token.

7. The method of claim 1, further comprising splitting the first sub-token into a third sub-token, a fourth sub-token, and a fifth sub-token in a single transaction, the third sub-token, the fourth sub-token, and the fifth sub-token being a faithful decomposition of the first sub-token.

8. The method of claim 1, wherein the non-interactive zero knowledge proof is discarded by the administrator of the blockchain after verification of the non-interactive zero knowledge proof.

9. The method of claim 1, wherein the non-interactive zero knowledge proof is posted to the blockchain.

10. One or more non-transitory computer-readable media containing instructions that, when executed by one or more processors, cause a system to perform operations, the operations comprising:
splitting an original token into a first sub-token and a second sub-token;
generating a first hash value of the first sub-token and a first randomness value;
generating a second hash value of the second sub-token and a second randomness value;
evaluating a non-interactive zero knowledge proof regarding the split of the original token into the first sub-token and the second sub-token;
sampling a first signature key and first verification key associated with the first sub-token and a second signature key and second verification key associated with the second sub-token;
generating a first signed value of a concatenation of the first hash value and the first verification key and signed using an initial signature key of a current owner of the original token;
generating a second signed value of a concatenation of the second hash value and the second verification key and signed using the initial signature key of the current owner of the original token; and
sending the non-interactive zero knowledge proof, the first hash value, the first signed value, the first verification key, the second hash value, the second signed value, and the second verification key to an administrator of a blockchain for posting to the blockchain.

11. The non-transitory computer-readable media of claim 10, wherein the non-interactive zero knowledge proof is based on an initial hash of the original token and an initial randomness value, the first hash value, and the second hash value.

12. The non-transitory computer-readable media of claim 10, wherein the first sub-token and the second sub-token are a faithful decomposition of the original token.

13. The non-transitory computer-readable media of claim 10, wherein the original token includes information from an issuer regarding a manner in which the original token may be split.

14. The non-transitory computer-readable media of claim 13, wherein the information includes at least one of a unit of time by which the original token is divisible, and a subset of rights associated with ownership of an asset associated with the original token that are divisible from a remainder of the rights associated with ownership of the asset.

15. The non-transitory computer-readable media of claim 10, the operations further comprising verifying that the blockchain includes an invalidation of an original list associated with the original token and the creation of a first new list associated with the firs sub-token and a second new list associated with the second sub-token.

16. The non-transitory computer-readable media of claim 10, the operations further comprising splitting the first sub-token into a third sub-token, a fourth sub-token, and a fifth sub-token in a single transaction, the third sub-token, the fourth sub-token, and the fifth sub-token being a faithful decomposition of the first sub-token.

17. The non-transitory computer-readable media of claim 10, wherein the non-interactive zero knowledge proof is discarded by the administrator of the blockchain after verification of the non-interactive zero knowledge proof

18. The non-transitory computer-readable media of claim 10, wherein the non-interactive zero knowledge proof is posted to the blockchain.

19. A system, comprising:
one or more processors; and
one or more non-transitory computer-readable media containing instructions that, when executed by the one or more processors, cause the system to perform operations, the operations comprising:
splitting an original token into a first sub-token and a second sub-token;
generating a first hash value of the first sub-token and a first randomness value;
generating a second hash value of the second sub-token and a second randomness value;
evaluating a non-interactive zero knowledge proof regarding the split of the original token into the first sub-token and the second sub-token;
sampling a first signature key and first verification key associated with the first sub-token and a second signature key and second verification key associated with the second sub-token;
generating a first signed value of a concatenation of the first hash value and the first verification key and signed using an initial signature key of a current owner of the original token;
generating a second signed value of a concatenation of the second hash value and the second verification key and signed using the initial signature key of the current owner of the original token; and
sending the non-interactive zero knowledge proof, the first hash value, the first signed value, the first verification key, the second hash value, the second signed value, and the second verification key to an administrator of a blockchain for posting to the blockchain.

20. The system of claim 19, wherein the non-interactive zero knowledge proof is based on an initial hash of the original token and an initial randomness value, the first hash value, and the second hash value, and the first sub-token and the second sub-token are a faithful decomposition of the original token.
